(19) United States
(12) Patent Application Publication
(10) Pub. No.: US 2006/0135672 A1
(43) Pub. Date: Jun. 22, 2006

(54) Polypropylene resin composition

(75) Inventor: Susumu Kanzaki, Chiba (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Sumitomo Chemical Company, Limited

(21) Appl. No.: 11/300,764

(22) Filed: Dec. 15, 2005

(30) Foreign Application Priority Data
Dec. 17, 2004 (JP) 2004-365797

(51) Int. Cl. C08K 3/34

(52) U.S. Cl. 524/451

(57) ABSTRACT

Disclosed is a polypropylene resin composition which includes a polypropylene resin, an ethylene-α-olefin copolymer rubber, and an inorganic filler, wherein the polypropylene resin includes a propylene-ethylene block copolymer composed of a polypropylene portion and a propylene-ethylene random copolymer portion, the weight ratio of the propylene units to the ethylene units in the propylene-ethylene random copolymer portion of the block copolymer is 75/25 to 35/65, the propylene-ethylene random copolymer portion of the block copolymer includes a first random copolymer component having an intrinsic viscosity of not less than 1.5 dl/g but less than 4 dl/g and an ethylene content of not less than 20% by weight but less than 50% by weight and a second random copolymer component having an intrinsic viscosity of not less than 0.5 dl/g but less than 3 dl/g and an ethylene content of not less than 50% by weight and not more than 80% by weight.

### BACKGROUND OF THE INVENTION

1. Field of the Invention

The present invention relates to polypropylene resin compositions and to injection molded articles made therefrom. Particularly, the invention relates to a polypropylene resin composition which is superior in low-temperature impact strength, especially in high rate surface impact strength, and which has well-balanced rigidity and surface hardness, and to a molded article made therefrom.

2. Description of the Related Art

Polypropylene resin compositions are materials excellent in rigidity, impact resistance, etc. and therefore are used for a wide variety of applications in the form, for example, of automotive interior or exterior components and housings of electric appliances.

For instance, JP 5-51498 A discloses a thermoplastic resin composition comprising 50-75% by weight of crystalline polypropylene, 15-35% by weight of ethylene-butene-1 copolymer rubber having a butene-1 content, an intrinsic viscosity and a Mooney viscosity each within a specific range, and 5-20% by weight of talc having an average particle diameter within a specific range.

JP 7-157626 A discloses a thermoplastic resin composition comprising a propylene-ethylene block copolymer prepared by multistage polymerization and a polyolefin rubber. This document teaches to use, as the propylene-ethylene block copolymer, a block copolymer composed of a block copolymer including a propylene-ethylene copolymer phase having an ethylene content of 5-50% by weight and an intrinsic viscosity of 4.0-8.0 dl/g and a block copolymer including a propylene-ethylene copolymer phase having an ethylene content of more than 50% by weight but not more than 98% by weight and an intrinsic viscosity of not less than 2.0 dl/g but less than 4.0 dl/g.

Moreover, JP 9-157492 A discloses a thermoplastic resin composition comprising a propylene-ethylene block copolymer prepared by multistage polymerization, an ethylene-butene copolymer rubber and talc. This document teaches to use, as the propylene-ethylene block copolymer, a block copolymer composed of a homopolypropylene portion whose melt flow rate is within a specific range and whose heat of fusion determined by DSC and melt flow rate satisfy a specific relationshiop, a propylene-ethylene copolymer portion having a low ethylene content and a propylene-ethylene copolymer portion having a high ethylene content.

However, molded articles made from the polypropylene resin compositions disclosed in the above-cited documents have been required to be improved in low-temperature impact strength, especially in high rate surface impact strength, and also in a balance between rigidity and surface hardness.

### SUMMARY OF THE INVENTION

Under such circumstances, the object of the present invention is to provide a polypropylene resin composition which is superior in low-temperature impact strength, especially in high rate surface impact strength, and which has well-balanced rigidity and surface hardness, and a molded article made therefrom.

In one aspect, the present invention provides

a polypropylene resin composition comprising:

from 50 to 94% by weight of a polypropylene resin (A),

from 1 to 25% by weight of an ethylene-α-olefin copolymer rubber (B) which includes ethylene units and α-olefin units having 4-12 carbon atoms and has a density of from 0.850 to 0.875 g/cm³, and

from 5 to 25% by weight of an inorganic filler (C), provided that the overall amount of the polypropylene resin composition is 100% by weight,

wherein the polypropylene resin (A) is a propylene-ethylene block copolymer (A-1) satisfying requirements (1), (2), (3) and (4) defined below or a polymer mixture (A-3) comprising the propylene-ethylene block copolymer (A-1) and a propylene homopolymer (A-2),

requirement (1): the block copolymer (A-1) is a propylene-ethylene block copolymer composed of from 55 to 85% by weight of a polypropylene portion and from 15 to 45% by weight of a propylene-ethylene random copolymer portion, provided that the overall amount of the block copolymer (A-1) is 100% by weight,

requirement (2): the polypropylene portion of the block copolymer (A-1) is a propylene homopolymer or a copolymer composed of propylene units and 1 mol % or less of units of a comonomer selected from the group consisting ethylene and α-olefin having 4 or more carbon atoms, provided that the overall amount of units constituting the copolymer is 100 mol %,

requirement (3): the weight ratio of the propylene units to the ethylene units in the propylene-ethylene random copolymer portion of the block copolymer (A-1) is from 75/25 to 35/65,

requirement (4): the propylene-ethylene random copolymer portion of the block copolymer (A-1) comprises a propylene-ethylene random copolymer component (EP-A) and a propylene-ethylene random copolymer component (EP-B), wherein the copolymer component (EP-A) has an intrinsic viscosity [η]_{EP-A} of not less than 1.5 dl/g but less than 4 dl/g and an ethylene content [(C2′)_{EP-A}] of not less than 20% by weight but less than 50% by weight and the copolymer component (EP-B) has an intrinsic viscosity [η]_{EP-B} of not less than 0.5 dl/g but less than 3 dl/g and an ethylene content [(C2′)_{EP-B}] of not less than 50% by weight and not more than 80% by weight.

In a preferred embodiment,

in the propylene-ethylene random copolymer portion included in the block copolymer (A-1), the intrinsic viscosity [η]_{EP-A} of the copolymer component (EP-A) is equal to or more than the intrinsic viscosity [η]_{EP-B} of the copolymer component (EP-B); or

the polypropylene portion of the block copolymer (A-1) has an intrinsic viscosity [η]_{P} of from 0.6 dl/g to 1.5 dl/g and a molecular weight distribution, as measured by GPC, of not less than 3 but less than 7; or

the polypropylene portion of the block copolymer (A-1) has an isotactic pentad fraction of 0.97 or more; or

the ethylene-α-olefin copolymer rubber (B) has a melt flow rate, as measured at a temperature of 230° C. and a load of 2.16 kgf, of from 0.05 to 30 g/10 min; or

the inorganic filler (C) is talc.

In another aspect, the present invention provides an injection molded article made from the polypropylene resin composition mentioned above.

By use of the present invention, a polypropylene resin composition and a molded article made therefrom which are superior in low-temperature impact strength, especially in high rate surface impact strength, and which have well-balanced rigidity and surface hardness.

### BRIEF DESCRIPTION OF THE DRAWINGS

FIG. 1 is a rough diagram of a chart of surface impact strength produced in a high rate surface impact test.

### DESCRIPTION OF THE PREFERRED EMBODIMENTS

The polypropylene resin composition of the present invention is a polypropylene resin composition including from 50 to 94% by weight of a polypropylene resin (A), from 1 to 25% by weight of an ethylene-α-olefin copolymer rubber (B), and from 5 to 25% by weight of an inorganic filler (C), provided that the overall amount of the polypropylene resin composition is 100% by weight.

The polypropylene resin (A) is a propylene-ethylene block copolymer (A-1) or a polymer mixture (A-3) including the block copolymer (A-1) and a propylene homopolymer (A-2).

The propylene-ethylene block copolymer (A-1) is a propylene-ethylene block copolymer including from 55 to 85% by weight of a polypropylene portion and from 15 to 45% by weight of a propylene-ethylene random copolymer portion, provided that the overall amount of the block copolymer (A-1) is 100% by weight, The propylene-ethylene block copolymer preferably includes from 55 to 80% by weight of a polypropylene portion and from 20 to 45% by weight of a propylene-ethylene random copolymer portion, and more preferably includes from 60 to 75% by weight of a polypropylene portion and from 25 to 40% by weight of a propylene-ethylene random copolymer portion.

When the amount of the polypropylene portion is less than 55% by weight, the rigidity or hardness of the polypropylene resin composition may be lowered or the polypropylene resin composition may have an insufficient moldability because of lowering of its fluidity, whereas when the amount of the polypropylene portion is over 85% by weight, the toughness or impact resistance of the polypropylene resin composition may be lowered. The propylene-ethylene block copolymer (A-1) may include an ethylene-α-olefin random copolymer portion including ethylene and α-olefin having from 4 to 12 carbon atoms. The content of the ethylene-α-olefin random copolymer portion is typically from 1 to 20% by weight.

The polypropylene portion of the block copolymer (A-1) is a propylene homopolymer or a copolymer including propylene units and 1 mol % or less of units of a comonomer selected from the group consisting ethylene and α-olefin having 4 or more carbon atoms, provided that the overall amount of units constituting the copolymer is 100 mol %.

In the case where the polypropylene portion of the block copolymer (A-1) is a copolymer including propylene units and units of comonomer selected from the group consisting of ethylene and α-olefins having 4 or more carbon atoms, when the content of the comonomer units is more than 1 mol %, the rigidity, heat resistance or hardness of the polypropylene resin composition may be lowered.

From the viewpoint of rigidity, heat resistance or hardness of the polypropylene resin composition, the polypropylene portion in the block copolymer (A-1) is preferably a propylene homopolymer, more preferably a propylene homopolymer having an isotactic pentad fraction, as measured by ¹³C-NMR, of 0.97 or more.

The isotactic pentad fraction is a fraction of propylene monomer units existing at the center of an isotactic chain in the form of a pentad unit, in other words, the center of a chain in which five propylene monomer units are meso-bonded successively, in the polypropylene molecular chain as measured by a method disclosed in A. Zambelli et al., Macromolecules, 6, 925 (1973), namely, by use of ¹³C-NMR. The assignment of NMR absorption peaks is carried out according to the disclosure of Macromolecules, 8, 687 (1975). Specifically, the isotactic pentad fraction was measured as an area fraction of mmmm peaks in all the absorption peaks in the methyl carbon region of a ¹³C-NMR spectrum. According to this method, the isotactic pentad fraction of an NPL standard substance, CRM No. M19-14 Polypropylene PP/MWD/2 available from NATIONAL PHYSICAL LABORATORY, G.B. was measured to be 0.944.

From the viewpoint of improvement in balance between the fluidity of the polypropylene resin composition when it is melted and the toughness of molded articles produced from the resin composition, the intrinsic viscosity [η]_{P} of the polypropylene portion in the block copolymer (A-1) is preferably from 0.6 to 1.5 dl/g, more preferably from 0.7 to 1.2 dl/g.

The molecular weight distribution as measured by gel permeation chromatography (GPC) is preferably not less than 3 but less than 7, more preferably from 3 to 5. As well known in the art, the molecular weight distribution, which is also referred to as a Q factor, is a ratio of the weight average molecular weight to the number average molecular weight, both average molecular weight being determined by GPC measurement.

The weight ratio of the propylene units to the ethylene units in the propylene-ethylene random copolymer portion of the block copolymer (A-1) is from 75/25 to 35/65, preferably from 70/30 to 40/60.

When the weight ratio of the propylene units to the ethylene units is outside the range from 75/25 to 35/65, the polypropylene resin composition may have an insufficient impact resistance.

The propylene-ethylene random copolymer portion of the block copolymer (A-1) comprises a propylene-ethylene random copolymer component (EP-A) and a propylene-ethylene random copolymer component (EP-B), wherein the copolymer component (EP-A) has an intrinsic viscosity [η]_{EP-A} of not less than 1.5 dl/g but less than 4 dl/g and an ethylene content [(C2′)_{EP-A}] of not less than 20% by weight but less than 50% by weight and the copolymer component (EP-B) has an intrinsic viscosity [η]_{EP-B} of not less than 0.5 dl/g but less than 3 dl/g and an ethylene content [(C2′)_{EP-B}] of not less than 50% by weight and not more than 80% by weight. The intrinsic viscosity is measured in Tetralin at 135° C.

The ethylene unit content [(C2′)_{EP-A}] of the copolymer component (EP-A) included in the propylene-ethylene random copolymer portion of the block copolymer (A-1) is not less than 20% by weight but less than 50% by weight. When the ethylene unit content [(C2′)_{EP-A}] is outside that range, the toughness or impact resistance of the polypropylene resin composition may be lowered. The ethylene unit content is preferably from 25 to 45% by weight.

The intrinsic viscosity [η]_{EP-A} of the copolymer component (EP-A) is not less than 1.5 dl/g but less than 4 dl/g, preferably not less than 2 dl/g but less than 4 dl/g.

When the intrinsic viscosity [η]_{EP-A} is less than 1.5 dl/g, the rigidity or hardness of the polypropylene resin composition may be lowered or the toughness or impact resistance of the polypropylene resin composition may also be lowered.

When the intrinsic viscosity [η]_{EP-A} is more than 4 dl/g, many hard spots may be formed in molded articles. When the content of the propylene-ethylene random copolymer portion in the block copolymer (A-1) is too much, the fluidity of the block copolymer (A-1) may be lowered.

The ethylene unit content [(C2′)_{EP-B}] of the copolymer component (EP-B) included in the propylene-ethylene random copolymer portion of the block copolymer (A-1) is from 50 to 80% by weight. When the ethylene unit content [(C2′)_{EP-B}] is outside that range, the impact resistance of the polypropylene resin composition at low temperatures may be lowered. The ethylene unit content is preferably from 55 to 75% by weight.

The intrinsic viscosity [η]_{EP-B} of the copolymer component (EP-B) is not less than 0.5 dl/g but less than 3 dl/g, preferably not less than 1 dl/g but less than 3 dl/g.

When the intrinsic viscosity [η]_{EP-B} is less than 0.5 dl/g, the rigidity or hardness of the polypropylene resin composition may be lowered or the toughness or impact resistance of the polypropylene resin composition may also be lowered.

When the intrinsic viscosity [η]_{EP-B} is more than 3 dl/g, the toughness or impact resistance of the polypropylene resin composition may be lowered. When the content of the propylene-ethylene random copolymer portion in the block copolymer (A-1) is too much, the fluidity of the block copolymer (A-1) may be lowered.

From the viewpoint of low-temperature impact resistance, the intrinsic viscosity [η]_{EP-A} of the copolymer component (EP-A) included in the propylene-ethylene random copolymer portion in the block copolymer (A-1) is preferably equal to or more than the intrinsic viscosity [η]_{EP-B} of the copolymer component (EP-B)

From the viewpoint of moldability or impact resistance of the polypropylene resin composition, the melt flow rate (MFR) of the propylene-ethylene block copolymer (A-1) is preferably from 5 to 120 g/10 min, more preferably from 10 to 100 g/10 min.

The propylene-ethylene block copolymers (A-1) is produced under appropriately selected conditions by a conventional polymerization method using a conventional polymerization catalyst.

One preferable example of the conventional polymerization catalyst to be used for the preparation of the propylene-ethylene block copolymer (A-1) is a catalyst composed of (a) a solid catalyst component including magnesium, titanium, halogen and electron donor as essential components, (b) an organoaluminum compound and (c) electron donor component. Examples of the method for preparing this type of catalyst include the methods disclosed in JP 1-319508 A, JP 7-216017 A and JP 10-212319 A.

The polymerization method for use in the preparation of the propylene-ethylene block copolymer (A-1) may be, for example, bulk polymerization, solution polymerization, slurry polymerization and gas phase polymerization. These polymerization methods may be carried out either batchwise or continuously. Moreover, these polymerization methods may optionally be combined together.

Preferable examples of such methods include:

(1) a continuous polymerization method using a polymerization system including at least three polymerization reactors arranged in series, wherein a polypropylene portion is formed in the presence of a catalyst composed of the aforementioned solid catalyst component (a), organoaluminum component (b) and electron donor component (c) in a first polymerization reactor; the polypropylene portion formed is transferred to a second polymerization reactor; in the second polymerization reactor, a propylene-ethylene random copolymer component (EP-A) is produced by polymerization; the product produced in the second polymerization reactor is transferred to a third polymerization reactor; in the third polymerization reactor, a propylene-ethylene random copolymer component (EP-B) is produced by polymerization; thus, a propylene-ethylene block copolymer (A-1) is produced, and

(2) a continuous polymerization method using a polymerization system including at least three polymerization reactors arranged in series, wherein a polypropylene portion is formed in the presence of a catalyst composed of the aforementioned solid catalyst component (a), organoaluminum component (b) and electron donor component (c) in a first polymerization reactor; the polypropylene portion formed is transferred to a second polymerization reactor; in the second polymerization reactor, a propylene-ethylene random copolymer component (EP-B) is produced by polymerization; the product produced in the second polymerization reactor is transferred to a third polymerization reactor; in the third polymerization reactor, a propylene-ethylene random copolymer component (EP-A) is produced by polymerization; thus, a propylene-ethylene block copolymer (A-1) is produced.

More concrete preferable examples are

(3) a continuous polymerization method using a polymerization system including at least three polymerization reactors arranged in series, wherein a polypropylene portion is formed in a first polymerization reactor in the presence of a catalyst composed of the aforementioned solid catalyst component (a), organoaluminum component (b) and electron donor component (c) and in the presence of hydrogen (molecular weight regulator) the concentration of which is adjust d so that a resulting polymer will have an intrinsic viscosity of from 0.6 to 1.5 dl/g; the polypropylene portion formed is transferred to a second polymerization reactor; in the second polymerization reactor, a propylene-ethylene random copolymer component (EP-A) is produced in the presence of hydrogen (molecular weight regulator) the concentration of which is adjusted so that the copolymer component will have an intrinsic viscosity [η]_{EP-A} of not less than 1.5 dl/g but less than 4 dl/g while adjusting the ethylene concentration and the propylene concentration so that the ethylene content [(C2′)_{EP-A}] will be a desired value (not less than 20% by weight but less than 50% by weight); the copolymer component (EP-A) is transferred to a third polymerization reactor; in the third polymerization reactor, a propylene-ethylene random copolymer component (EP-B) is produced in the presence of hydrogen (molecular weight regulator) the concentration of which is adjusted so that the copolymer component will have an intrinsic viscosity [η]_{EP-B} of not less than 0.5 dl/g but less than 3 dl/g while adjusting the ethylene concentration and the propylene concentration so that the ethylene content [(C2′)_{EP-B}] will be a desired value (from 50% by weight to 80% by weight); thus, a propylene-ethylene block copolymer (A-1) is produced, and

(4) a continuous polymerization method using a polymerization system including at least three polymerization reactors arranged in series, wherein a polypropylene portion is formed in a first polymerization reactor in the presence of a catalyst composed of the aforementioned solid catalyst component (a), organoaluminum component (b) and electron donor component (c) and in the presence of hydrogen (molecular weight regulator) the concentration of which is adjusted so that a resulting polymer will have an intrinsic viscosity of from 0.6 to 1.5 dl/g; the polypropylene portion formed is transferred to a second polymerization reactor; in the second polymerization reactor, a propylene-ethylene random copolymer component (EP-B) is produced in the presence of hydrogen (molecular weight regulator) the concentration of which is adjusted so that the copolymer component will have an intrinsic viscosity [η]_{EP-B} of not less than 0.5 dl/g but less than 3 dl/g while adjusting the ethylene concentration and the propylene concentration so that the ethylene content [(C2′)_{EP-B}] will be a desired value (from 50% by weight to 80% by weight); the copolymer component (EP-B) is transferred to a third polymerization reactor; in the third polymerization reactor, a propylene-ethylene random copolymer component (EP-A) is produced in the presence of hydrogen (molecular weight regulator) the concentration of which is adjusted so that the copolymer component will have an intrinsic viscosity [η]_{EP-A} of not less than 1.5 dl/g but less than 4 dl/g while adjusting the ethylene concentration and the propylene concentration so that the ethylene content [(C2′)_{EP-A}] will be a desired value (not less than 20% by weight but less than 50% by weight); thus, a propylene-ethylene block copolymer (A-1) is produced. From the industrial and economic points of view, continuous gas phase polymerization is preferred.

The amounts of the solid catalyst component (a), the organoaluminum compound (b) and the electron-donating component (c), and the methods for feeding these catalyst components in the aforementioned polymerization methods may be determined optionally.

The polymerization temperature is typically from −30 to 300° C., preferably from 20 to 180° C. The polymerization pressure is typically from normal pressure to 10 MPa, preferably from 0.2 to 5 MPa. The molecular weight regulator may be hydrogen.

In the production of the propylene-ethylene block copolymer (A-1), preliminary polymerization may be carried out before main polymerization. An available method of preliminary polymerization is polymerization carried out by feeding a small amount of propylene in the presence of a solid catalyst component (a) and an organoaluminum compound (b) in a slurry state using a solvent.

Additives may optionally be added to the polypropylene resin (A). Examples of the additives include antioxidants, UV absorbers, lubricants, pigments, antistatic agents, copper inhibitors, flame retardants, neutralizing agents, foaming agents, plasticizers, nucleating agent, antifoaming agents and crosslinking agents. For improvement in heat resistance, weatherability and stability against oxidization, it is preferable to add an antioxidant or a UV absorber.

As the polypropylene resin (A) included in the polypropylene resin composition of the present invention, a propylene-ethylene block copolymer (A-1) may be used alone. Alternatively, a polymer mixture (A-3) including a propylene-ethylene block copolymer (A-1) and a propylene homopolymer (A-2) may be used.

In typical cases, the content of the propylene-ethylene block copolymer (A-1) included in the polymer mixture (A-3) is from 30 to 99% by weight and the content of the propylene homopolymer (A-2) is from 1 to 70% by weight. The content of the propylene-ethylene block copolymer (A-1) is preferably from 50 to 90% by weight and the content of the propylene homopolymer (A-2) is preferably from 10 to 50% by weight. The polymer mixture (A-3) may include a propylene-ethylene block copolymer (A-4) which includes less than 15% by weight of a propylene-ethylene random copolymer portion. The content of the propylene-ethylene block copolymer (A-4) is typically from 1 to 50% by weight.

The propylene homopolymer (A-2) is preferably a homopolymer having an isotactic pentad fraction of 0.97 or more, more preferably a homopolymer having an isotactic pentad fraction of 0.98 or more.

The melt flow rate (MFR), as measured at a temperature of 236° C. and a load of 2.16 kgf, of the propylene homopolymer (A-2) is typically from 20 to 500 g/10 min, preferably from 80 to 300 g/10 min.

The propylene homopolymer (A-2) can be produced by polymerization using a catalyst similar to that for use in the preparation of the propylene-ethylene block copolymer (A-1).

The content of the polypropylene resin (A) included in the polypropylene resin composition of the present invention is from 50 to 94% by weight, preferably from 55 to 90% by weight, and more preferably from 60 to 85% by weight, provided that the overall amount of the polypropylene resin composition is 100% by weight.

When the content of the polypropylene resin (A) is less than 50% by weight, the rigidity of the polypropylene resin composition may be lowered, whereas when the content is over 94% by weight, the impact strength of the polypropylene resin composition may be lowered.

The ethylene-α-olefin copolymer rubber (B) as used herein is an ethylene-α-olefin copolymer rubber which includes α-olefin units having 4-12 carbon atoms and ethylene units and which has a density of from 0.850 to 0.875 g/cm³.

Examples of the α-olefin having 4-12 carbon atoms include butene-1, pentene-1, hexene-1, heptene-1, octene-1 and decene. Butene-1, hexene-1 and octene-1 are preferred.

The content of α-olefin units included in the copolymer rubber (B) is typically from 20 to 50% by weight, preferably from 24 to 50% by weight from the viewpoint of impact strength, particularly low-temperature impact strength, of the polypropylene resin composition, provided that the overall amount of the copolymer rubber (B) is 100% by weight.

Examples of the ethylene-α-olefin copolymer rubber (B) include an ethylene-butene-1 random copolymer rubber, an ethylene-hexene-1 random copolymer rubber and an ethylene-octene-1 random copolymer rubber. An ethylene-octene-1 random copolymer or an ethylene-butene-1 random copolymer is preferred. Two or more ethylene-α-olefin copolymer rubbers may be used together.

Moreover, the ethylene-α-olefin random copolymer rubber may include ethylene units, units of α-olefin having 4 to 12 carbon atoms and another copolymerized units (e.g., propylene units and nonconjugated polyene units). Specific examples of such ethylene-α-olefin random copolymer rubber include an ethylene-propylene-butene-1 random copolymer rubber having an ethylene unit content of from 30 to 80% by weight, a butene-1 unit content of from 20 to 50% by weight and a propylene unit content of from 10 to 30% by weight and an ethylene-α-olefin (C4-12)-nonconjugated polyene random copolymer rubber having an ethylene unit content of from 30 to 80% by weight, an α-olefin (C4-12) unit content of from 20 to 50% by weight and a nonconjugated polyene unit content of from 1 to 10% by weight. Examples of the nonconjugated polyene include acyclic dienes such as 5-ethylidene-2-norbornene, 5-propylidene-5-norbornene, dicyclopentadiene, 5-vinyl-2-norbornene and norbornadiene; linear nonconjugated dienes such as 1,4-hexadiene, 4-methyl-1,4-hexadiene, 5-methyl-1,4-heptadiene, 5-methyl-1,5-heptadiene, 6-methyl-1,5-heptadiene, 6-methyl-1,7-octadiene and 7-methyl-1,6-octadiene; and trienes such as 2,3-diisopropylidene-5-norbornene. Such nonconjugated polyenes may be used singly or in combination. Among those provided above as examples, 1,4-hexadiene, dicyclopentadiene and 5-ethylidene-2-norbornene are preferred.

The density of the ethylene-α-olefin copolymer rubber (B) is from 0.850 to 0.875 g/cm³, preferably from 0.850 to 0.870 g/cm³. When the density of the ethylene-α-olefin copolymer rubber (B) exceeds 0.875 g/cm³, the impact strength, particularly low-temperature impact strength, of the polypropylene resin composition may be lowered.

The melt flow rate, as measured at a temperature of 230° C. and a load of 2.16 kgf, of the ethylene-α-olefin copolymer rubber (B) is preferably from 0.05 to 30 g/10 min, more preferably from 0.05 to 15 g/10 min from the viewpoint of impact strength, particularly low-temperature impact strength, of the polypropylene resin composition of the present invention.

The ethylene-α-olefin copolymer rubber (B) can be prepared by copolymerizing ethylene and various α-olefin using a conventional catalyst and a conventional polymerization method.

Examples of the conventional catalyst include a catalyst system composed of a vanadium compound and an organoaluminum compound, a Ziegler-Natta catalyst system or a metallocene catalyst system. The conventional polymerization method may be solution polymerization, slurry polymerization, high pressure ion polymerization or gas phase polymerization.

The content of the ethylene-α-olefin copolymer rubber (B) included in the polypropylene resin composition of the present invention is from 1 to 25% by weight, preferably from 3 to 22% by weight, and more preferably from 5 to 20% by weight, provided that the overall amount of the polypropylene resin composition is 100% by weight.

When the content of the ethylene-α-olefin copolymer rubber (B) is less than 1% by weight, the impact strength of the polypropylene resin composition may be lowered, whereas when the content is over 25% by weight, the rigidity of the polypropylene resin composition may be lowered.

Examples of the inorganic filler (C) used in the present invention include calcium carbonate, barium sulfate, mica, crystalline calcium silicate, talc and fibrous magnesium oxysulfate. Talc or fibrous magnesium oxysulfate is preferred. Two or more kinds of inorganic filler may be used together.

The talc to be used as inorganic filler (C) is preferably one prepared by grinding hydrous magnesium silicate. The crystal structure of molecules of hydrous magnesium silicate is a pyrophyllite type three-layer structure. Talc comprises a lamination of this structure, and more preferably is a tabular powder resulting from fine pulverization of crystals of hydrous magnesium silicate molecules almost to their unit layers.

The average particle diameter of talc is preferably 3 μm or less. By the average particle diameter of talc is meant a 50% equivalent particle diameter D50 calculated from an integrated distribution curve by the minus sieve method measured by suspending talc in a dispersion medium (water or alcohol) using a centrifugal sedimentation particle size distribution measuring device.

Inorganic filler (C) may be used without being subjected to any treatment or may be used after being surface treated with a silane coupling agent, titanium coupling agent, higher fatty acid, higher fatty acid ester, higher fatty acid amide, higher fatty acid salt or other surfactants for improving interfacial adhesiveness with or dispersibility in the polypropylene resin (A).

The average fiber length of fibrous magnesium oxysulfate to be used as the inorganic filler (C) is preferably from 5 to 50 μm, more preferably from 10 to 30 μm. The fibrous magnesium oxysulfate preferably has an average fiber diameter of from 0.3 to 2 μm, more preferably from 0.5 to 1 μm.

The content of the inorganic filler (C) included in the polypropylene resin composition of the present invention is from 5 to 25% by weight, preferably from 7 to 23% by weight, and more preferably from 10 to 21% by weight, provided that the overall amount of the polypropylene resin composition is 100% by weight.

When the content of the inorganic filler (C) is less than 5% by weight, the rigidity of the polypropylene resin composition may be lowered, whereas when the content is over 25% by weight, the impact strength of the polypropylene resin composition may be lowered.

The polypropylene resin composition of the present invention can be produced by melt-kneading its components. For the kneading, a kneading device such as a single screw extruder, a twin screw extruder, a Banbury mixer and heated rolls can be used. The kneading temperature is typically from 170 to 250° C., and the kneading time is typically from 1 to 20 minutes. All the components may be kneaded at the same time or successively.

The method for kneading the components successively may be any of options (1), (2) and (3) shown below.

(1) A method which comprises kneading and pelletizing a propylene-ethylene block copolymer (A-1) first and then kneading the pellets, an ethylene-α-olefin copolymer rubber (B) and an inorganic filler (C) together.

(2) A method which comprises kneading and pelletizing a propylene-ethylene block copolymer (A-1) first and then kneading the pellets, a propylene homopolymer (A-2), an ethylene-α-olefin copolymer rubber (B) and an inorganic filler (C) together.

(3) A method which comprises kneading a propylene-ethylene block copolymer (A-1) and an ethylene-α-olefin copolymer rubber (B), and then adding an inorganic filler (C), followed by kneading.

(4) A method which comprises kneading a propylene-ethylene block copolymer (A-1) and an inorganic filler (C) and then adding an ethylene-α-olefin copolymer rubber (B), followed by kneading.

In the method (3) or (4), a propylene homopolymer (A-2) may optionally be added.

The polypropylene resin composition of the present invention may include various types of additives, examples of which include antioxidants, UV absorbers, lubricants, pigments, antistatic agents, copper inhibitors, flame retardants, neutralizing agents, foaming agents, plasticizers, nucleating agent, antifoaming agents and crosslinking agents. For improvement in heat resistance, weatherability and stability against oxidization, it preferably includes an antioxidant or a UV absorber. The content of each of such additives is typically from 0.001% by weight to 1% by weight.

The polypropylene resin composition of the present invention may include an aromatic vinyl compound-containing rubber to improve the balance of mechanical properties.

The aromatic vinyl compound-containing rubber as used herein may be a block copolymer composed of aromatic vinyl compound polymer blocks and conjugated diene polymer blocks. Moreover, hydrogenated block copolymers derived from block copolymers composed of aromatic vinyl compound polymer blocks and conjugated diene polymer blocks through hydrogenation at all or part of their double bonds in their conjugated diene blocks are also available. The degree of hydrogenation of the double bonds of the conjugated diene polymer blocks is preferably 80% by weight or more, more preferably 85% by weight or more, provided that the overall amount of the double bonds in the conjugated diene polymer blocks is 100% by weight.

The molecular weight distribution, as determined by gel permeation chromatography (GPC), of the aromatic vinyl compound-containing rubber is preferably 2.5 or less, more preferably from 1.0 to 2.3.

The content of units derived from aromatic vinyl compounds is preferably from 10 to 20% by weight, more preferably from 12 to 19% by weight, provided that the overall amount of the aromatic vinyl compound-containing rubber is 100% by weight.

The melt flow rate (MFR), as measured at a temperature of 230° C. and a load of 2.16 kgf according to JIS K6758, of the aromatic vinyl compound-containing rubber is preferably from 0.01 to 15 g/10 min, more preferably from 0.03 to 13 g/10 min.

Specific examples of the aromatic vinyl compound-containing rubber include block copolymers such as styrene-ethylene-butene-styrene rubber (SEBS), styrene-ethylene-propylene-styrene rubber (SEPS), styrene-butadiene rubber (SBR), styrene-butadiene-styrene rubber (SBS) and styrene-isoprene-styrene rubber (SIS), and block copolymers resulting from hydrogenation of the foregoing block copolymers. Furthermore, rubbers obtained by causing an aromatic vinyl compound such as styrene to react with an ethylene-propylene-nonconjugated diene rubber (EPDM) may also be used. Two or more aromatic vinyl compound-containing rubbers may be used in combination.

The aromatic vinyl compound-containing rubber may be produced by a method in which an aromatic vinyl compound is bonded to an olefin-based copolymer rubber or a conjugated diene rubber through polymerization or a reaction.

The injection molded article of the present invention is one obtained by a known injection molding of the polypropylene resin composition of the present invention. Such an injection molded article is superior in low-temperature impact strength, especially in high rate surface impact strength, and which has well-balanced rigidity and surface hardness, reflecting the characteristics of the polypropylene resin composition used as a raw material thereof.

The injection molded article of the present invention can be suitably used particularly as automotive components such as door trims, pillars, instrument panels and bumpers.

### EXAMPLES

The present invention will be explained below with reference to examples and comparative example. Methods for measuring physical properties of the polymers and compositions of the present invention and of those of the Examples and Comparative Examples are described below.

(1) Intrinsic Viscosity (Unit: dl/g)

Reduced viscosities were measured at three points of concentrations of 0.1, 0.2 and 0.5 g/dl using a Ubbelohde's viscometer. The intrinsic viscosity was calculated by a calculation method described in “Kobunshi Yoeki (Polymer Solution), Kobunshi Jikkengaku (Polymer Experiment Study) 11” page 491 (published by Kyoritsu Shuppan Co., Ltd., 1982), namely, by an extrapolation method in which reduced viscosities are plotted against concentrations and the concentration is extrapolated in zero. The measurements were carried out at 135° C. using Tetralin as a solvent.

(1-1) Intrinsic Viscosity of Propylene-Ethylene Block Copolymer

(1-1a) Intrinsic Viscosity of Polypropylene Portion: [η]_{P}

The intrinsic viscosity [η]_{P} of the polypropylene portion included in a propylene-ethylene block copolymer was determined by the method described in (1) above using some polymer powder sampled from a polymerization reactor just after the first step for producing the polypropylene portion during the production of the propylene-ethylene block copolymer.

(1-1b) Intrinsic Viscosity of Propylene-Ethylene Random Copolymer Portion: [η]_{EP}

The intrinsic viscosity [η]_{P} of the propylene homopolymer portion included in a propylene-ethylene block copolymer and the intrinsic viscosity [η]_{T} of the propylene-ethylene block copolymer were measured by the method described in (1) above. Then, the intrinsic viscosity [η]_{EP} of the propylene-ethylene random copolymer portion in the propylene-ethylene block copolymer was determined from the equation provided below by use of a weight ratio, X, of the propylene-ethylene random copolymer to the propylene-ethylene block copolymer. The weight ratio X was determined by the means of (2) provided below.
[η]_{EP}=[η]_{T}/X−(1/X−1)[η]_{P}

[η]_{P}: Intrinsic viscosity (dl/g) of propylene homopolymer portion

[η]_{T}: Intrinsic viscosity (dl/g) of propylene-ethylene block copolymer

When a propylene-ethylene random copolymer portion was produced by two-stage polymerization, the intrinsic viscosity [η]_{EP-1} of the first propylene-ethylene random copolymer portion (EP-1), the intrinsic viscosity [η]_{EP-2} of the propylene-ethylene random copolymer portion (EP-2) produced in the second stage and the intrinsic viscosity [η]_{EP} of the propylene-ethylene random copolymer portion in the finally formed propylene-ethylene block copolymer including EP-1 and EP-2 were determined by the methods (b-1), (b-3) and (b-2), respectively.

(b-1) Intrinsic Viscosity: [η]_{EP-1}

Just after the preparation of the propylene ethylene random copolymer portion (EP-1) which was formed firstly in the two-stage polymerization, a sample thereof taken out from the polymerization reactor was measured for its intrinsic viscosity [η]₍₁₎. Then, the intrinsic viscosity [η]_{EP-1} of the propylene-ethylene random copolymer portion (EP-1) firstly obtained was determined in a manner equivalent to the above-mentioned (1-1b).
[η]_{EP-1}=[η]₍₁₎/X₍₁₎−1/X₍₁₎−1)[η]_{P}

[η]_{P}: Intrinsic viscosity (dl/g) of propylene homopolymer portion

[η]₍₁₎: Intrinsic viscosity (dl/g) of the propylene-ethylene block copolymer after the polymerization of EP-1

X₍₁₎: Weight ratio of EP-1 to the propylene-ethylene block copolymer after the polymerization of EP-1

(b-2) Intrinsic Viscosity: [η]_{EP}

The intrinsic viscosity [η]EP of the propylene-ethylene random copolymer portion in the propylene-ethylene block copolymer including EP-1 and EP-2 finally formed in the two-stage polymerization was determined by a method equivalent to that of (1-1b).
[η]_{EP}=[η]_{T}/X−(1/X−1)[η]_{P}

[η]_{P}: Intrinsic viscosity (dl/g) of propylene homopolymer portion

[η]_{T}: Intrinsic viscosity (dl/g) of the finally-formed propylene-ethylene block copolymer

X: Weight ratio of the finally-formed propylene-ethylene random copolymer portion to the finally-formed propylene-ethylene block copolymer

(b-3) Intrinsic Viscosity: [η]EP-2

The intrinsic viscosity [η]_{EP-2} of the propylene-ethylene random copolymer portion (EP-2) formed in the second stage of the two-stage polymerization was determined from the intrinsic viscosity [η]_{EP} of the propylene-ethylene block copolymer finally produced, the intrinsic viscosity [η]_{EP-1} of the propylene-ethylene random copolymer portion (EP-1) firstly formed and their weight ratios.
[η]_{EP-2}=([η]_{EP}×X−[η]_{EP-1}×X₁)/X₂

X₁: Weight ratio of EP-1 to the propylene-ethylene block copolymer finally produced
X₁=(X₍₁₎−X×X₍₁₎)/(1−X₍₁₎)

X₂: Weight ratio of EP-2 to the propylene-ethylene block copolymer finally produced
X₂=X−X₁
(2) Weight Ratio of the Propylene-Ethylene Random Copolymer Portion to the Propylene-Ethylene Block Copolymer: X and Ethylene Content of the Propylene-Ethylene Random Copolymer Portion in the Propylene-Ethylene Block Copolymer: [(C2′)_{EP}]

The above values were calculated from a ¹³C-NMR spectrum measured as described below according to the report of Kakugo, et al. (Macromolecules, 15, 1150-1152 (1982)).

In a test tube having a diameter of 10 mm, about 200 mg of a propylene-ethylene block copolymer was uniformly dissolved in 3 ml of o-dichlorobenzene to yield a sample solution, which was measured for its ¹³C-NMR spectrum under the following conditions:

Temperature: 135° C.

Pulse repeating time: 10 seconds

Pulse width: 45°

Accumulation number: 2500 times

(3) Melt Flow Rate (MFR, Unit: g/10 min)

The melt flow rate was measured according to the method provided in JIS K6758. The measurement was carried out at a temperature of 230° C. and a load of 2.16 kg, unless otherwise stated.

(4) Flexural Modulus (FM, unit: MPa)

The flexural modulus was measured according to the method provided in JIS K 7203. The measurement was carried out at a load rate of 5 mm/min and a temperature of 23° C. using an injection molded specimen having a thickness of 3.2 mm and a span length of 60 mm.

(5) Izod Impact Strength (Izod, Unit: kJ/m²)

The Izod impact strength was measured according to the method provided in JIS K 7110. The measurement was carried out at a temperature of 23° C. or −30° C. using a 6.4-mm thick notched specimen which was produced by injection molding followed by notching.

(6) Heat Distortion Temperature (HDT, Unit: ° C.)

The heat distortion temperature was measured according to the method provided in JIS K 7207 at a fiber stress of 4.6 kgf/cm².

(7) Rockwell Hardness (R Scale)

The Rockwell hardness was measured according to the method provided in JIS K 7202. It was measured using a specimen having a thickness of 3.0 mm prepared by injection molding. The measurements are shown in R scale.

(8) High Rate Surface Impact Resistance Test

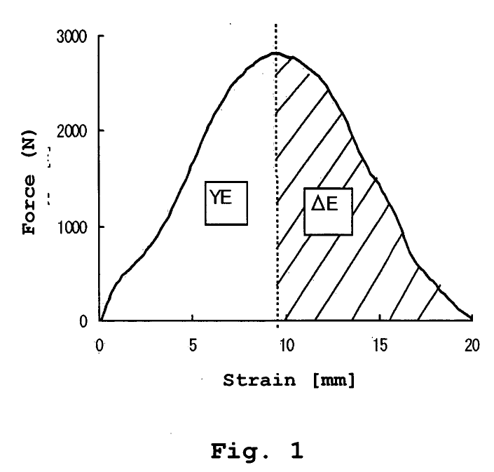

A flat specimen with dimensions 100×100×3 (mm) cut out from an injection molded flat plate with dimensions 100×400×3 (mm) was held in a 1-inch circular holder of a High Rate Impact Tester (Model RIT-8000) manufactured by Rheometrics (USA). While an impact probe with a diameter of ½ inch (the radius of the top spherical surface: ¼ inch) was applied to the specimen at a rate of 5 m/sec, the distortion of the specimen and the stress were detected and a curve like that shown in FIG. 1 was produced. The integral area was calculated and thereby the surface impact strength was evaluated.

The yield point energy (YE), which is the energy required before a material yields and the total energy (TE), which is the energy required before the material fails were measured. The surface impact strength was evaluated on the basis of the energy (ΔE) necessary for plastic deformation after the yielding, which is the difference between (TE) and (YE).

In general, when the (ΔE) is great, the material desirably tends to be resistant to brittle fracture. All the energies are expressed in Joule (J). The conditioning was carried out in a thermostatic chamber included in the device. A specimen was placed in the thermostatic chamber adjusted to a predetermined temperature and was conditioned for two hours. Subsequently, it was subjected to the above-mentioned test. The predetermined temperature was used as a measurement temperature. One example of surface impact strength is shown in FIG. 1. The abscissa represents the distortion of the specimen and the ordinate represents the stress detected at a distortion. The measurement chart was produced by detecting both values continuously and plotting them continuously on an X-Y plotter. The yield point energy (YE) was calculated by area integration of the distortion and the stress from the rising point of the detected stress and the point of yielding of the material. The total energy (TE) was calculated by area integration of the distortion and the stress from the rising point to the point of fracture of the material. (ΔE) was calculated on the basis of the difference between (TE) and (YE). The test was repeated fifteen times (n=15) and their average, namely (average ΔE), was calculated.

Regarding the state of fracture, ductile fracture (D), brittle fracture (B) and semi-ductile fracture (SD), which is similar to ductile fracture but corresponds to a state where some cracks extend from the circumference of a hole formed by penetration of an impact probe, were judged through observation of a fracture test piece of an actual material were determined.

(9) Isotactic Pentad Fraction

The isotactic pentad fraction is a fraction of propylene monomer units existing at the center of an isotactic chain in the form of a pentad unit, in other words, the center of a chain in which five propylene monomer units are meso-bonded successively, in the polypropylene molecular chain as measured by a method disclosed in A. Zambelli et al., Macromolecules, 6, 925 (1973), namely, by use of ¹³C-NMR. The assignment of NMR absorption peaks was conducted according to Macromolecules, 8, 687 (1975).

Specifically, the isotactic pentad fraction was measured as an area fraction of mmmm peaks in all the absorption peaks in the methyl carbon region of a ¹³C-NMR spectrum. According to this method, the isotactic pentad fraction of an NPL standard substance, CRM No. M19-14 Polypropylene PP/MWD/2 available from NATIONAL PHYSICAL LABORATORY, G. B. was measured to be 0.944.

(10) Molecular Weight Distribution

The molecular weight distribution was measured by gel permeation chromatography (GPC) under the following conditions:

Instrument: Model 150CV (manufactured by Millipore Waters Co.)

Column: Shodex M/S 80

Measurement temperature: 145° C.

Solvent: o-Dichlorobenzene

Sample concentration: 5 mg/8 mL

A calibration curve was produced using a standard polystyrene. The Mw/Mn of a standardpolystyrene (NBS706; Mw/Mn=2.0) measured under the above conditions was 1.9-2.0.

(11) Density

The density of a polymer was measured according to the method provided in JIS K7112.

[Production of Injection Molded Article 1]

Specimens (injection-molded articles) for evaluation of physical properties in the above-mentioned (4)-(7) were prepared by injection molding at a molding temperature of 220° C., a mold cooling temperature of 50° C., an injection time of 15 seconds and a cooling time of 30 seconds using an injection molding machine, model IS150E-V, manufactured by Toshiba Machine Co., Ltd.

[Production of Injection Molded Article 2]

A specimen (injection molded article) for evaluation of high rate surface impact strength described in (8) was prepared by the following method.

That is, the specimen was prepared by injection molding at a molding temperature of 220° C., a mold cooling temperature of 50° C., an injection time of 15 seconds and a cooling time of 30 seconds using an injection molding machine, model SE180D, manufactured by Sumitomo Heavy Industries, Ltd.

The methods for preparing three types of catalyst (solid catalyst components (I), (II) and (III)) used in the preparations of the polymers used in Examples and Comparative Examples are shown below.

(1) Solid Catalyst Component (I)

(1-1) Preparation of Reduced Solid Product

A 500-ml flask equipped with a stirrer and a dropping funnel was purged with nitrogen, and then 290 ml of hexane, 8.9 ml (8.9 g, 26.1 mmol) of tetrabutoxytitanium, 3.1 ml (3.3 g, 11.8 mmol) of diisobutyl phthalate and 87.4 ml (81.6 g, 392 mmol) of tetraethoxysilane were fed therein to yield a homogeneous solution. Subsequently, 199 ml of a solution of n-butylmagnesium chloride in di-n-butyl ether (manufactured by Yuki Gosei Kogyo Co., Ltd., n-butylmagnesium chloride concentration: 2.1 mmol/ml) was slowly added dropwise from the dropping funnel thereto over 5 hours while the temperature in the flask was maintained at 6° C. After completion of the dropping, the mixture was stirred at 6° C. for 1 hour, and additionally stirred for 1 hour at room temperature. Thereafter, the mixture was subjected to solid-liquid separation. The resulting solid was washed repeatedly with three portions of 260-ml toluene and then a proper amount of toluene was added thereto to adjust the slurry concentration to 0.176 g/ml. After sampling a part of the solid product slurry, its composition analysis was conducted, and as a result, the solid product was found to include 1.96% by weight of titanium atoms, 0.12% by weight of phthalic acid ester, 37.2% by weight of ethoxy groups and 2.8% by weight of butoxy groups.

(1-2) Preparation of Solid Catalyst Component

A 100 ml flask equipped with a stirrer, a dropping funnel and a thermometer was purged with nitrogen. Then, 52 ml of the slurry including the solid product obtained in the above (1) was fed in the flask, and 25.5 ml of supernatant was removed. Following addition of a mixture of 0.80 ml (6.45 mmol) of di-n-butyl ether and 16.0 ml (0.146 mol) of titanium tetrachloride and subsequent addition of 1.6 ml (11.1 mmol: 0.20 ml/1 g-solid product), the system was heated to 115° C. and stirred for 3 hours. After completion of the reaction, the reaction mixture was subjected to solid-liquid separation at that temperature. The resulting solid was washed with two portions of 40-ml toluene at that temperature. Subsequently, 10.0 ml of toluene and a mixture of 0.45 ml (1.68 mmol) of diisobutyl phthalate, 0.80 ml (6.45 mmol) of di-n-butyl ether and 8.0 ml (0.073 mol) of titanium tetrachloride were added to the solid, followed by a treatment at 115° C. for 1 hour. After completion of the reaction, the reaction mixture was subjected to solid-liquid separation at that temperature. The resulting solid was then washed with three portions of 40-ml toluene at that temperature and additionally with three portions of 40-ml hexane, and then dried under reduced pressure to yield 7.36 g of a solid catalyst component. The solid catalyst component was found to include 2.18% by weight of titanium atoms, 11.37% by weight of phthalic acid ester, 0.3% by weight of ethoxy groups and 0.1% by weight of butoxy groups. An observation of the solid catalyst component by a stereomicroscope revealed that the component included no fine powder and had a good powder property. This solid catalyst component is henceforth called solid catalyst component (I).

(2) Solid Catalyst Component (II)

A 200-L SUS reactor equipped with a stirrer was purged with nitrogen, and then 80 L of hexane, 6.55 mol of tetrabutoxytitanium and 98.9 mol of tetraethoxysilane were fed to form a homogeneous solution. Subsequently, 50 L of a solution of butylmagnesium chloride in diisobutyl ether with a concentration of 2.1 mol/L was added dropwise slowly over 4 hours while holding the temperature in the reactor at 20° C. After completion of the dropping, the mixture was stirred at 20° C. for 1 hour and then subjected to solid-liquid separation at room temperature. The resulting solid was washed repeatedly with three portions of 70-L toluene. Subsequently, following removal of toluene so that the slurry concentration became 0.4 kg/L, a liquid mixture of 8.9 mol of di-n-butyl ether and 274 mol of titanium tetrachloride was added. Then, 20.8 mol of phthaloyl chloride was further added, followed by a reaction at 110° C. for 3 hours. After completion of the reaction, the reaction mixture was washed with three portions of toluene at 95° C. Subsequently, the slurry concentration was adjusted to 0.4 kg/L and then 3.13 mol of diisobutyl phthalate, 8.9 mol of di-n-butyl ether and 109 mol of titanium tetrachloride were added, followed by a reaction at 105° C. for 1 hour. After completion of the reaction, the reaction mixture was subjected to solid-liquid separation at that temperature. The resulting solid was washed with two portions of 90-L toluene at 95° C. Subsequently, the slurry concentration was adjusted to 0.4 kg/L and then 8.9 mol of di-n-butyl ether and 109 mol of titanium tetrachloride were added, followed by a reaction at 95° C. for 1 hour. After completion of the reaction, the reaction mixture was subjected to solid-liquid separation at that temperature. The resulting solid was washed with two portions of 90-L toluene at that temperature. Subsequently, the slurry concentration was adjusted to 0.4 kg/L and then 8.9 mol of di-n-butyl ether and 109 mol of titanium tetrachloride were added, followed by a reaction at 95° C. for 1 hour. After completion of the reaction, the reaction mixture was subjected to solid-liquid separation at that temperature. The resulting solid was then washed with three portions of 90-L toluene at that temperature and additionally with three portions of 90-L hexane, and then dried under reduced pressure to yield 12.8 kg of a solid catalyst component. The solid catalyst component included 2.1% by weight of titanium atoms, 18% by weight of magnesium atoms, 60% by weight of chlorine atoms, 7.15% by weight of phthalic acid ester, 0.05% by weight of ethoxy groups, 0.26% by weight of butoxy groups. The component included no fine powder and had a good powder property. This solid catalyst component is henceforth called solid catalyst component (II).

(3) Solid Catalyst Component (III)

A 200-L cylindrical reactor having a diameter of 0.5 m which was equipped with a stirrer having three pairs of blades 0.35 m in diameter and also equipped with four baffle plates 0.05 m wide was purged with nitrogen. Into the reactor, 54 L of hexane, 100 g of diisobutyl phthalate, 20.6 kg of tetraethoxy silane and 2.23 kg of tetrabutoxy titanium were charged and stirred. Then, to the stirred mixture, 51 L of a solution of butylmagnesium chloride in dibutyl ether (concentration=2.1 mol/L) was dropped over 4 hour while the temperature inside the reactor was held at 7° C. The stirring speed during this operation was 150 rpm. After completion of the dropping, the mixture was stirred at 20° C. for 1 hour and then was filtered. The resulting solid was washed with three portions of 70-L toluene at room temperature, followed by addition of toluene to yield a slurry of solid catalyst component precursor. The solid catalyst component precursor included 1.9% by weight of Ti, 35.6% by weight of OEt (ethoxy group) and 3.5% by weight of OBu (butoxy group). It had an average particle diameter of 39 μm and included fine powder component with a diameter of up to 16 μm in an amount of 0.5% by weight. Then, toluene was drained so that the slurry volume became 49.7 L and the residue was stirred at 80° C. for 1 hour. After that, the slurry was cooled to a temperature of 40° C. or lower and a mixture of 30 L of titanium tetrachloride and 1.16 kg of di-n-butyl ether was added under stirring. Moreover, 4.23 kg of orthophthaloyl chloride was charged. After being stirred for 3 hours at a temperature inside the reactor of 110° C., the mixture was filtered and the resulting solid was washed with three portions of 90-L toluene at 95° C. Toluene was added to the solid to form slurry, which was subsequently left stand. Toluene was then drained so that the slurry volume became 49.7 L. Thereafter, a mixture of 15 L of titanium tetrachloride, 1.16 kg of di-n-butyl ether and 0.87 kg of diisobutyl phthalate was charged. After being stirred for 1 hour at a temperature inside the reactor of 105° C., the mixture was filtered and the resulting solid was washed with two portions of 90-L toluene at 95° C. Toluene was added to the solid to form slurry, which was left stand. Toluene was then drained so that the slurry volume became 49.7 L. Thereafter, a mixture of 15 L of titanium tetrachloride and 1.16 kg of di-n-butyl ether was charged. After being stirred for 1 hour at a temperature inside the reactor of 105° C., the mixture was filtered and the resulting solid was washed with two portions of 90-L toluene at 95° C. Toluene was added to the solid to form a slurry, which was left stand. Toluene was then drained so that the slurry volume became 49.7 L. Thereafter, a mixture of 15 L of titanium tetrachloride and 1.16 kg of di-n-butyl ether was charged. After being stirred for 1 hour at a temperature inside the reactor of 105° C., the mixture was filtered and the resulting solid was washed at 95° C. with three portions of 90-L toluene and additionally with two portions of 90-L hexane. The resulting solid component was dried to yield a solid catalyst component, which included 2.1% by weight of Ti and 10.8% by weight of phthalic acid ester. This solid catalyst component is henceforth called solid catalyst component (III).

[Preparation of Polymer by Polymerization]

(1) Preparation of Propylene Homopolymer (HPP)

(1-1) Preparation of HPP-1

(1-1a) Preliminary Polymerization

In a 3-L SUS autoclave equipped with a stirrer, 25 mmol/L of triethylaluminum (hereinafter abbreviated as TEA) and tert-butyl-n-propyldimethoxysilane (hereinafter abbreviated as tBunPrDMS) as an electron-donating component in a tBunPrDMS-to-TEA ratio of 0.1 (mol/mol) and also 19.5 g/L of the solid catalyst component (III) were added to hexane which had been fully dehydrated and degassed. Subsequently, preliminary polymerization was carried out by feeding propylene continuously until the amount of the propylene became 2.5 g per gram of the solid catalyst while keeping the temperature at 15° C. or lower. The resulting preliminary polymer slurry was transferred to a 120-L SUS dilution tank with a stirrer, diluted by addition of a fully refined liquid butane, and preserved at a temperature of 10° C. or lower.

(1-1b) Main Polymerization

In a fluidized bed reactor having a capacity of 1 m³ and equipped with a stirrer, propylene and hydrogen were fed so as to keep a polymerization temperature of 83° C., a polymerization pressure of 1.8 MPa-G and a hydrogen concentration in the gas phase of 17.9 vol % relative to propylene. Continuous gas phase polymerization was carried out while continuously feeding 43 mmol/h of TEA, 6.3 mmol/h of cyclohexylethyldimethoxysilane (hereinafter abbreviated as CHEDMS) and 1.80 g/h of the preliminary polymer slurry prepared in (1-1a) as solid catalyst components. Thus, 18.6 kg/h of polymer was obtained. The resulting polymer had an intrinsic viscosity [η]_{P} of 0.78 dl/g, an isotactic pentad fraction of 0.985 and a molecular weight distribution of 4.3. The results of the analysis of the resulting polymer are shown in Table 1.

(1-2) Preparation of HPP-2

(1-2a) Preliminary Polymerization

The preliminary polymerization was carried out in the same manner as HPP-1 except the solid catalyst component was changed to solid catalyst component (I).

(1-2b) Main Polymerization

Main polymerization was carried out in the same manner as HPP-1 except the electron-donating compound in the main polymerization was changed to tBunPrDMS and the hydrogen concentration in the gas phase and the amount of the solid catalyst component supplied were adjusted so that the polymer given in Table 1 was produced.

The results of the analysis of the resulting polymer are shown in Table 1.

(2) Preparation of Propylene-Ethylene Block Copolymer (BCPP)

(2-1) Preparation of BCPP-1

(2-1a) Preliminary Polymerization

In a 3-L SUS autoclave equipped with a stirrer, 65 mmol/L of TEA and tBunPrDMS as an electron-donating component in a tBunPrDMS-to-TEA ratio of 0.2 (mol/mol) and also 22.5 g/L of the solid catalyst component (II) were added to hexane which had been fully dehydrated and degassed. Subsequently, preliminary polymerization was carried out by feeding propylene continuously until the amount of the propylene became 2.5 g per gram of the solid catalyst while keeping the temperature at 15° C. or lower. The resulting preliminary polymer slurry was transferred to a 200-L SUS dilution tank with a stirrer, diluted by addition of a fully refined liquid butane, and preserved at a temperature of 10° C. or lower.

(2-1b) Main Polymerization

Two fluidized bed reactors each having a capacity of 1 m³ equipped with a stirrer were placed in series. Main polymerization was carried out by gas phase polymerization in which a propylene polymer portion was produced by polymerization in a first reactor and then was transferred continuously to a second reactor without being deactivated and a propylene-ethylene copolymer portion was produced continuously by polymerization in the second reactor.

In the first reactor in the former step, propylene and hydrogen were fed so as to keep a polymerization temperature of 80° C., a polymerization pressure of 1.8 MPa and a hydrogen concentration in the gas phase of 16 vol %. Under such conditions, continuous polymerization was carried out while 20.4 mmol/h of TEA, 4.2 mmol/h of tBunPrDMS and 1.23 g/h of the preliminary polymer slurry prepared in (2-1a) as a solid catalyst component were fed, affording 15.6 kg/h of polymer. The polymer had an intrinsic viscosity [η]_{P} of 0.93 dl/g and an isotactic pentad fraction of 0.983.

The discharged polymer was fed continuously to the second reactor for the latter step without being deactivated. In the second reactor, propylene, ethylene and hydrogen were continuously fed so as to keep a polymerization temperature of 65° C., a polymerization pressure of 1.4 MPa, a hydrogen concentration in the gas phase of 1.64 vol % and an ethylene concentration of 13.0 vol %. Under such conditions, a continuous polymerization was continued while 6.0 mmol/h of tetraethoxysilane (hereinafter abbreviated as TES) was fed. Thus, 21.1 kg/h of polymer was obtained. The resulting polymer had an intrinsic viscosity [η]_{T} of 1.33 dl/g and the polymer content (EP content) in the portion produced in the latter step was 25% by weight. Therefore, the polymer produced in the latter step portion (EP portion) had an intrinsic viscosity [η]_{EP} of 2.5 dl/g. An analysis revealed that the ethylene content of the EP portion was 30% by weight. The results of the analysis of the resulting polymer are shown in Table 1.

(2-2) Preparation of BCPP-2

Polymerization was carried out in the same manner as in the preparation of BCPP-1 except solid catalyst component (III) was used as a solid catalyst component used in preliminary polymerization and the hydrogen concentration and the ethylene concentration in the gas phase and the amount of the solid catalyst component supplied in main polymerization were adjusted so that a polymer given in Table 2 was produced. The results of the analysis of the resulting polymer are shown in Table 1.

(2-3) Preparation of BCPP-3

(2-3a) Preliminary Polymerization

Preliminary polymerization was carried out in the same manner as in the preparation of BCPP-1.

(2-3b) Main Polymerization

Two fluidized bed reactors each having a capacity of 1 m³ equipped with a stirrer were placed in series. Main polymerization was carried out by gas phase polymerization in which a propylene polymer portion was produced by polymerization in a first reactor and then was transferred to a second reactor without being deactivated and a propylene-ethylene copolymer portion was produced batchwise by semibatch polymerization in the second reactor.

In the first reactor for the former stage, propylene and hydrogen were fed so as to keep a polymerization temperature of 80° C., a polymerization pressure of 1.8 MPa-G and a hydrogen concentration in the gas phase of 10 vol %. Under such conditions, continuous polymerization was carried out while 30 mmol/h of TEA, 4.5 mmol/h of tBunPrDMS and 1.2 g/h of the preliminary polymer slurry prepared in (2-3a) as a solid catalyst component were fed, affording 20.3 kg/h of polymer. The polymer had an intrinsic viscosity [η]_{P} of 1.04 dl/g. The second reactor for the latter stage was filled in advance with nitrogen gas at 0.3 MPa. After the receipt of the polymer transferred from the first reactor, 22 mmol of TES was added to the second reactor.

Then, batch polymerization, which is referred to as EP-1 polymeriztion, was carried out under conditions where propylene, ethylene and hydrogen were fed continuously so that a polymerization temperature of 65° C., a polymerization pressure of 1.2 MPa, a hydrogen concentration of 2.1 vol % and a ethylene concentration of 20 vol % in the gas phase were maintained. Thus, 41.7 kg of polymer was produced.

A part of the polymer formed was removed from the second reactor. Analysis of the polymer revealed that the polymer content (EP-1 content) in the latter stage was 14.7% by weight. Therefore, the intrinsic viscosity [η]_{EP-1} of the polymer (EP-1 portion) formed in the latter stage was 2.6 dl/g. The ethylene content in the EP-1 portion was 35 wt. %.

Moreover, batch polymerization, which is referred to as EP-2 polymeriztion, was carried out under conditions where propylene, ethylene and hydrogen were fed continuously so that a polymerization temperature of 65° C., a polymerization pressure of 1.4 MPa, a hydrogen concentration of 9.1 vol % and a ethylene concentration of 45.8 vol % in the gas phase of the second reactor in the latter stage were maintained. Thus, 50.9 kg of polymer was finally produced. Analysis of the polymer collected revealed that the intrinsic viscosity [η]_{T} of of the polymer was 1.48 dl/g and the polymer content in the later stage (EP) was 29% by weight. Therefore, the polymer (EP portion) produced in the latter stage had an intrinsic viscosity [η]_{EP} of 2.6 dl/g. The ethylene content in the EP portion was 52 wt. %.

Therefore, the intrinsic viscosity [η]_{EP-2} of the propylene-ethylene copolymer portion produce in the EP-2 polymerization was calculated to be 2.6 dl/g and the ethylene content in the EP-2 portion was also calculated to be 65% by weight.

The results of the analysis of the resulting polymer are shown in Table 1.

Preparation of BCPP-4

Polymerization was carried out in the same manner as in the preparation of BCPP-3 except the hydrogen concentration and the ethylene concentration in the gas phase and the amount of the solid catalyst component supplied in main polymerization were adjusted so that a polymer given in Table 2 was produced. The results of the analysis of the resulting polymer are shown in Table 1.

Preparation of BCPP-5

Solid catalyst component (I) was used as a solid catalyst component used in preliminary polymerization and cyclohexylethyldimethoxysilane (hereinafter abbreviated as CHEDMS) was used as an electron-donating component. Polymerization was carried out in the same manner as in the preparation of BCPP-3 except the hydrogen concentration and the ethylene concentration in the gas phase and the amount of the solid catalyst component supplied in main polymerization were adjusted so that a polymer given in Table 2 was produced. The results of the analysis of the resulting polymer are shown in Table 1.

### Example 1

To 100 parts by weight of a propylene-ethylene block copolymer poweder (BCPP-3), 0.05 part by weight of calcium stearate (manufactured by NOF Corp.), 0.05 part by weight of 3,9-bis[2-{3-(3-tert-butyl-4-hydroxy-5-methylphenyl)propion yloxy}-1,1-dimethylethyl]-2,4,8,10-tetraoxaspiro[5.5]undeca ne (Sumilizer GA80, manufactured by Sumitomo Chemical Co., Ltd.), and 0.05 parts by weight of bis(2,4-di-tert-butylphenyl)pentaerythritol diphosphite (Ultranox U626, manufactured by GE Specialty Chemicals) were added as stabilizers and dry blended. The resulting mixture was pelletized by means of a 40-mmφ single screw extruder (at 220° C.)

65% by weight of pellets of BCPP-3, 8% by weight of a powder of propylene homopolymer (HPP-1), 11% by weight of ethylene-octene-1 random copolymer rubber EOR-1 (Engage 8200 manufactured by Du Pont Dow Elastomer L.L.C., density=0.870 g/cm³, MFR=11 g/10 min) as the ethylene-α-olefin copolymer rubber (B) and 16% by weight of talc having an average particle diameter of 2.7 μm (commercial name: MWHST, manufactured by Hayashi Kasei Co., Ltd.) were blended and preliminarily mixed uniformly in a tumbler. Then, the mixture was kneaded and extruded using a twin screw kneading extruder (Model TEX44SS 30BW-2V manufactured by The Japan Steel Works, Ltd.) at an extrusion rate of 50 kg/hr, 230° C. and a screw speed of 350 rpm. In Table 2, the compounding amounts of the components, the MFR and results of evaluation of physical properties of the pelletized polypropylene resin composition are shown.

### Example-2 to Example-4, Comparative Example-1 to Comparative Example-2

Treatment the same as that of Example-1 was carried out except using a propylene-ethylene block copolymer(s) (BCPP) shown in Tables 2 and 3, and the MFR and physical properties of injection molded articles were measured. The MFR and physical properties are shown in Table 2 and Table 3.

### Comparative Example-3 and Comparative Example-4

Treatment the same as that of Example-1 was carried out except using a propylene-ethylene block copolymer (BCPP) shown in Table 3 and changing the ethylene-octene-1 random copolymer rubber EOR-1 to an ethylene-butene-1 random copolymer rubber EBR-1 (Esprene SPO, NO377 manufactured by Sumitomo Chemical Co., Ltd., density=0.890 g/cm³, MFR=35 g/10 min), and the MFR and physical properties of injection molded articles were measured. The MFR and physical properties are shown in Table 3.

TABLE 1

| | | Propylene | | Propylene-ethylene block | | | | |
|---|---|---|---|---|---|---|---|---|
| | | homopolymer | | copolymer | | | | |
| | | HPP-1 | HPP-2 | BCPP-1 | BCPP-2 | BCPP-3 | BCPP-4 | BCPP-5 |
| [η]P | dl/g | 0.78 | 0.97 | 0.93 | 0.97 | 1.04 | 0.98 | 0.92 |
| [η]EP | dl/g | | | 2.5 | 2.2 | 2.6 | 2.5 | 2.5 |
| (C′2)EP | wt % | | | 30 | 47 | 52 | 47 | 46 |
| EP content | wt % | | | 25 | 24 | 29 | 41 | 31 |
| [η]EP-1 | dl/g | | | — | — | 2.6 | 2.4 | 2.3 |
| (C′2)EP-1 | wt % | | | — | — | 35 | 36 | 30 |
| [η]EP-2 | dl/g | | | — | — | 2.6 | 2.5 | 2.6 |
| (C′2)EP-2 | wt % | | | — | — | 65 | 51 | 54 |
| MFR | g/10 min | | | 25 | 31 | 17 | 14 | 21 |

TABLE 2

| | | Exam- | Exam- | Exam- | Exam- |
|---|---|---|---|---|---|
| | | ple 1 | ple 2 | ple 3 | ple 4 |
| BCPP-3 | wt % | 65 | 57 | | |
| BCPP-4 | wt % | | | 43 | |
| BCPP-5 | wt % | | | | 61 |
| HPP-1 | wt % | 8 | 16 | | |
| HPP-2 | wt % | | | 30 | 12 |
| EOR-1 | wt % | 11 | 11 | 11 | 11 |
| Talc | wt % | 16 | 16 | 16 | 16 |
| MFR | g/10 min | 20 | 26 | 24 | 25 |
| Flexural modulus | MPa | 1634 | 1788 | 1710 | 1712 |
| IZOD 23° C. | kJ/m² | 52 | 45 | 51 | 46 |
| IZOD −30° C. | kJ/m² | 6.9 | 5.6 | 5.0 | 5.0 |
| Rockwell hardness | R scale | 45 | 53 | 53 | 51 |
| Heat distortion | ° C. | 123 | 125 | 126 | 123 |
| temperature | | | | | |
| High rate surface | | | | | |
| impact resistance | | | | | |
| test at −30° C. | | | | | |
| The number of ductile | fractures | 15 | 4 | 15 | 8 |
| fractures (D) | | | | | |
| The number of | fractures | 0 | 8 | 0 | 7 |
| semiductile | | | | | |
| fractures (SD) | | | | | |
| The number of brittle | fractures | 0 | 3 | 0 | 0 |
| fractures (B) | | | | | |
| Average ΔE | J | 18 | 17 | 18 | 17 |

TABLE 3

| | | Com- | | | |
|---|---|---|---|---|---|
| | | parative | Com- | Com- | Com- |
| | | Exam- | parative | parative | parative |
| | | ple-1 | Example-2 | Example-3 | Example-4 |
| BCPP-1 | wt % | | 22 | | |
| BCPP-2 | wt % | 73 | 51 | 73 | |
| BCPP-3 | wt % | | | | 60 |
| HPP-1 | wt % | | | | 13 |
| EOR-1 | wt % | 11 | 11 | | |
| EBR-1 | wt % | | | 11 | 11 |
| Talc | wt % | 16 | 16 | 16 | 16 |
| MFR | g/10 min | 26 | 23 | 26 | 22 |
| Flexural | MPa | 1690 | 1658 | 1729 | 1708 |
| modulus | | | | | |
| IZOD 23° C. | kJ/m² | 46 | 48 | 33 | 40 |
| IZOD −30° C. | kJ/m² | 5.4 | 5.1 | 4.8 | 4.8 |
| Rockwell | R scale | 45 | 45 | 48 | 49 |
| hardness | | | | | |
| Heat | ° C. | 125 | 126 | 120 | 123 |
| distortion | | | | | |
| temperature | | | | | |
| High rate | | | | | |
| surface impact | | | | | |
| resistance | | | | | |
| test at −30° C. | | | | | |
| The number of | fractures | 9 | 9 | 1 | 3 |
| ductile | | | | | |
| fractures (D) | | | | | |
| The number of | fractures | 3 | 3 | 7 | 2 |
| semiductile | | | | | |
| fractures (SD) | | | | | |
| The number of | fractures | 3 | 3 | 7 | 10 |
| brittle | | | | | |
| fractures (B) | | | | | |
| Average ΔE | J | 15 | 15 | 15 | 11 |

It is shown that the polypropylene resin compositions of Examples-1 to 4 and molded articles produced therefrom are 5 superior in low-temperature impact strength, particularly in high rate surface impact strength (ΔE), and have well-balanced rigidity and surface hardness.

It is shown that in Comparative Examples-1 and 2, the high rate surface impact strength (ΔE) and the balance between rigidity and surface hardness are insufficient because the propylene-ethylene random copolymer portion in the polypropylene resin does not include a propylene-ethylene random copolymer component (EP-A) and a propylene ethylene random copolymer component (EP-B) which satisfy a requirement of the present invention.

It is found that in Comparative Examples-3 and 4, the high rate surface impact strength (ΔE) and the balance between rigidity and surface hardness are insufficient because the density of the ethylene-α-olefin copolymer rubber does not satisfy a requirement of the present invention.

The polypropylene resin composition of the present invention can be used in applications in which a high quality is demanded such as automotive interior or exterior components.

What is claimed is:

1. A polypropylene resin composition comprising:
from 50 to 94% by weight of a polypropylene resin (A),
from 1 to 25% by weight of an ethylene-α-olefin copolymer rubber (B) which includes ethylene units and α-olefin units having 4-12 carbon atoms and has a density of from 0.850 to 0.875 g/cm³, and
from 5 to 25% by weight of an inorganic filler (C), provided that the overall amount of the polypropylene resin composition is 100% by weight,
wherein the polypropylene resin (A) is a propylene-ethylene block copolymer (A-1) satisfying requirements (1), (2), (3) and (4) defined below or a polymer mixture (A-3) comprising the propylene-ethylene block copolymer (A-1) and a propylene homopolymer (A-2),
requirement (1): the block copolymer (A-1) is a propylene-ethylene block copolymer composed of from 55 to 85% by weight of a polypropylene portion and from 15 to 45% by weight of a propylene-ethylene random copolymer portion, provided that the overall amount of the block copolymer (A-1) is 100% by weight,
requirement (2): the polypropylene portion of the block copolymer (A-1) is a propylene homopolymer or a copolymer composed of propylene units and 1 mol % or less of units of a comonomer selected from the group consisting ethylene and α-olefin having 4 or more carbon atoms, provided that the overall amount of units constituting the copolymer is 100 mol %,
requirement (3): the weight ratio of the propylene units to the ethylene units in the propylene-ethylene random copolymer portion of the block copolymer (A-1) is from 75/25 to 35/65,
requirement (4): the propylene-ethylene random copolymer portion of the block copolymer (A-1) comprises a propylene-ethylene random copolymer component (EP-A) and a propylene-ethylene random copolymer component (EP-B), wherein the copolymer component (EP-A) has an intrinsic viscosity [η]EP-A of not less than 1.5 dl/g but less than 4 dl/g and an ethylene content [(C2′)_{EP-A}] of not less than 20% by weight but less than 50% by weight and the copolymer component (EP-B) has an intrinsic viscosity [η]_{EP-B} of not less than 0.5 dl/g but less than 3 dl/g and an ethylene content [(C2′)_{EP-B}] of not less than 50% by weight and not more than 80% by weight.

2. The polypropylene resin composition according to claim 1, wherein in the propylene-ethylene random copolymer portion included in the block copolymer (A-1), the intrinsic viscosity [η]_{EP-A} of the copolymer component (EP-A) is equal to or more than the intrinsic viscosity [η]_{EP-B} of the copolymer component (EP-B).

3. The polypropylene resin composition according to claim 1, wherein the polypropylene portion of the block copolymer (A-1) has an intrinsic viscosity [η]_{P} of from 0.6 dl/g to 1.5 dl/g and a molecular weight distribution, as measured by GPC, of not less than 3 but less than 7.

4. The polypropylene resin composition according to claim 1, wherein the polypropylene portion of the block copolymer (A-1) has an isotactic pentad fraction of 0.97 or more.

5. The polypropylene resin composition according to claim 1, wherein the ethylene-α-olefin copolymer rubber (B) has a melt flow rate, as measured at a temperature of 230° C. and a load of 2.16 kgf, of from 0.05 to 30 g/10 min.

6. The polypropylene resin composition according to claim 1, wherein the inorganic filler (C) is talc.

7. An injection molded article made from the polypropylene resin composition according to claim 1.
